(19) United States
(12) Patent Application Publication
(10) Pub. No.: US 2023/0288198 A1
(43) Pub. Date: Sep. 14, 2023

(54) SENSOR UNIT

(71) Applicant: elobau GmbH & Co. KG, Leutkirch (DE)

(72) Inventors: Michael Sonntag, Karlsruhe (DE); Michael Prinz, Leutkirch (DE)

(21) Appl. No.: 18/102,980

(22) Filed: Jan. 30, 2023

(30) Foreign Application Priority Data
Mar. 10, 2022 (DE) 10 2022 105 605.8

(51) Int. Cl. G01C 9/06

(52) U.S. Cl. CPC G01C 9/06

(57) ABSTRACT

A sensor unit comprising an electronics unit, a first housing part and a second housing part connected thereto is provided. The first and second housing parts form an interior between them and, directed away therefrom, each of them has a housing part outer side. The electronics unit is connected to the first housing part and projects into the interior, wherein a contact area passing through the first housing part is provided. The electronics unit has at least one circuit board with at least two circuit board portions connected to one another in an electrically conductive manner, wherein a first circuit board portion is arranged between the contact area and a second circuit board portion in an electrically conductive manner.

This U.S. patent application claims priority to German patent application no. 10 2022 105 605.8, filed Mar. 10, 2022, the entire contents of which is incorporated herein by reference in its entirety.

### BACKGROUND

### 1. Technical Field

The present invention relates to a sensor unit comprising an electronics unit, a first housing part and a second housing part connected thereto, wherein the electronics unit is connected to the first housing part and projects into the interior, wherein a contact area passing through the first housing part is provided, wherein the electronics unit has at least one circuit board with at least two circuit board portions which are connected to one another in electrically conductive manner.

### 2. Related Art

Sensor units, in particular position or inclination sensors, are used, among other things, in harsh environments determined by strong environmental influences. In addition, they are attached to a wide variety of machine units, such as vehicles or production machines, and must therefore be designed in a correspondingly diverse manner.

From the prior art, sensor units are known which have a contact area on or in a housing for electrical connection to the respective machine unit as well as a circuit board, wherein the circuit board and contact area are usually connected to each other by means of insulated cables within the housing of the sensor unit. To protect the circuit board as well as the cables and contact area within the housing from external influences, the remaining volume of the housing is usually filled with a silicone or resin, for example. This protects these components securely but makes subsequent changes or modulations to the sensor unit hardware more difficult. The circuit board is no longer accessible or recyclable without destruction.

U.S. Pat. No. 4,864,156 discloses a proximity switch comprising a main housing, an adapter housing and a sensor housing, wherein one circuit board is arranged in each housing and the circuit boards of the adapter housing and the sensor housing are connected to one another in an electrically conductive manner and the circuit boards of the adapter housing and the main housing are electrically isolated from one another.

US 2003/0123242 A1 discloses a housing for a sensor, wherein the sensor housing has a coating on at least one side of the housing, which coating is particularly resistant to external influences such as welding flashes. Furthermore, the housing has three housing parts which define an interior in which an electronics unit is arranged.

### SUMMARY

The present invention therefore has the object to provide a robust and easily transformable sensor unit which can be assembled in the simplest possible manner.

This object is achieved by a sensor unit comprising an electronics unit, a first housing part and a second housing part connected thereto, wherein the first and second housing parts form an interior between them and, directed away therefrom, each of them has a housing part outer side, wherein the electronics unit is connected to the first housing part and projects into the interior, wherein a contact area passing through the first housing part is provided, wherein the electronics unit has at least one circuit board with at least two circuit board portions connected to one another in an electrically conductive manner, wherein a first circuit board portion is arranged in an electrically conductive manner between the contact area and a second circuit board portion.

The first and second housing parts are advantageously reversibly connected to each other in a nonpositive or positive manner in order to make the interior easily accessible to a user in the event of a possible adaptation of the electronics unit. They are preferably formed from a plastics with high strength, rigidity, and very good frictional resistance, advantageously from ABS or PBT, in particular reinforced with glass fiber. According to the invention, the interior is designed in such a manner that, in addition to all the components arranged in the interior, it also accommodates a gas, in particular ambient air or nitrogen, which prevents possible temperature fluctuations due to external influences that may affect the measurement results. According to the invention, the use of a gas, such as nitrogen, to fill the interior prevents the interior from catching fire in the event of a malfunction of the sensor unit. The electronics unit is at least indirectly connected to the first housing part, in particular in a nonpositive and/or positive manner. The contact area has at least one contact point and a contact frame, wherein the contact frame is integrally connected to the first housing part or, alternatively, positively or nonpositively connected thereto. According to the invention, electronic components are arranged on the first or the second circuit board portion depending on their intended use. According to the invention, the first and second circuit board portions can be formed in one piece or as two individual circuit boards, even locally separated from each other. The advantage of using two individual and independently arranged circuit board portion is their flexible possibility to be combined with each other. Accordingly, all electronic components having one task are advantageously arranged on one circuit board section and those having another task are arranged on another circuit board portion. This results in a modular principle so that depending on the application, the sensor unit can be optimally adapted to the respective requirements. This allows a high degree of modularity and applicability in a wide variety of application areas with only a minor change to a section of the electronics unit. The electrically conductive arrangement of the first circuit board portion between the contact area and the second circuit board portion contributes significantly to the aforementioned advantages of the invention since as a result of this, a standardized connection between the first and second circuit board portions is formed and the circuit board portions can be interconnected and used independently of the electronic components arranged thereon or an arranged contact area.

In one configuration of the invention, it is provided that in the operating state, the first circuit board portion transmits electrical voltage and/or current applied to the contact area to the second circuit board portion substantially unchanged. In a particularly advantageous manner, the electronic components which are designed for contacting the contact area and thus for connection to the rest of the machine are arranged on the first circuit board portion so that, if necessary, only the first circuit board portion has to be adapted when the contact area is changed. An arrangement of further electronic components on the first circuit board portion, in particular of illuminants or visual indicators, which are functional independently of the electronic components arranged on the second circuit board portion, is also advantageous. Furthermore, in a particularly advantageous manner, electronic components such as fuses, in particular fine-wire fuses or 0 Ω resistors, are arranged on the first circuit board portion for flexible electrical contacting between the at least one contact point and various regions of the first circuit board portion. The electronic components necessary for the actual function of the sensor unit do not have to be rearranged since the electromagnetic interference fields of the changing first circuit board portion have only a minor or no influence due to the delimited arrangement. Similarly, there is the possibility to arrange the first circuit board portion with a contact area suitable for a machine unit to a functionally different second circuit board portion to obtain multiple differently acting sensor units for one slot. In other words, the advantage is twofold: on the one hand, a manufacturer of the sensors according to the invention can very easily adapt a sensor already designed for a machine should a change occur on the machine side; on the other hand, the manufacturer can arrange different sensors in one and the same housing with one and the same contact area, thus providing the machine manufacturer with different sensors to choose from without the machine manufacturer having to provide different contact options.

Advantageously, the first housing part is substantially plate-shaped such that it covers a smaller part of the part of the electronics unit projecting into the interior of the housing than the second housing part. Due to the substantially plate-shaped first housing part, all components are freely accessible during assembly of the electronics unit and reaching into a narrow interior is not necessary. Here, the plate-shaped design of the first housing part is to be understood primarily as meaning that the first housing part has its maximum cross-sectional area parallel to its main plane.

In one refinement of the invention, it is provided that the first housing part covers less than 30%, in particular less than 20%, preferably less than 10% of the part of the electronics unit projecting into the interior. Accordingly, in a particularly advantageous manner, all units which are arranged in the interior can be assembled on the first housing part and are also easily accessible. The second housing part closes off the interior so that the electronics unit is securely accommodated therein.

In one configuration of the invention, it is provided that a circuit board portion of the electronics unit is oriented substantially parallel to the main plane of the plate-shaped first housing part and that the electronics unit is attached therewith at least indirectly to the first housing part, and/or that the two circuit board portions are arranged substantially orthogonal to each other. In a particularly advantageous manner, the contact frame of the contact area is arranged parallel to and, depending on the nature of the contact points, close to the circuit board portion arranged parallel to the main plane, and the at least one contact point is arranged substantially orthogonal to the contact frame and to the circuit board portion arranged parallel to the main plane. Transmission cables, which would require additional accommodation space and are also susceptible to damage from shock or vibration, are advantageously avoided. The fewer electrical contact points are required, the lower is the risk of damage, destruction or faulty manufacture of one of them. The fixed connection between the circuit board portion arranged parallel to the main plane and the contact area by direct soldering of the at least one contact point to the circuit board portion arranged parallel to the main plane enables reliable positioning of the electronics unit by means of a positive and/or nonpositive connection between the contact area and the first housing part, which minimizes damage to the latter and to the contact area. In this case, the at least one contact point is positively and/or nonpositively connected to the contact frame, wherein the at least one contact point is in particular press-fitted to the contact frame. The design of the contact frame as a separate component from the first housing part is advantageous since due its flat main surface aligned parallel to the first circuit board portion, the at least one contact point can be machine-soldered onto the first circuit board portion in an arrangement predefined by the contact frame, in particular by means of wave soldering. In the case of a one-piece design of the contact frame with the first housing part, the dimensional compliance required for correct positioning of the at least one contact point is simplified due to the smaller number of tolerance ranges. In this embodiment, reliable positioning of the electronics unit can be established via a positive connection between the electronics unit and the first housing part. The orthogonal arrangement of the two circuit board portions is particularly advantageous, as this forms a space-saving and modular electronics unit.

It is further advantageous that the sensor unit has a support structure attached to the first housing part and contacting the electronics unit, wherein the support structure is preferably designed to be guided in a guide of the second housing part. The support structure is preferably detachably connected to the first housing part and/or the electronics unit. In particular, the connection is designed as a nonpositive or positive connection, particularly preferably as a screw connection. The support structure is designed in such a manner that between the support structure and the electronics unit a connection is formed which is as rigid as possible for the direct transmission of occurring forces or vibrations. In this manner, the electronics unit, in addition to the support structure, contributes to the increase of the overall strength of the sensor unit.

In a refinement of the invention, a molded seal is arranged between the first and second housing parts. The molded seal advantageously seals the interior from dirt, water and dust and, in particular, the interior also has at least protection class IP 68 as a result thereof. The molded seal is advantageously made of a rubber, in particular EPDM, NBR, FKM or BR.

In one configuration of the invention, it is provided that the contact area is formed bordered by a molded extension of the first housing part. The molded extension advantageously protects the contact area from damage. Provided that the contact area is formed as one with many contact points projecting away from the main plane, the molded extension has at least the length of the projecting contact points to protect them from damage. Advantageously, the molded extension has molded extension grooves. A design of the molded extension grooves as molded extension webs is also advantageous in order to ensure a safe insertion of the contact area into a machine unit and to minimize as far as possible transverse forces occurring in the contact area, which could lead to damage. Preferably, the molded extension is designed in such a manner that it prevents faulty contact between the contact area and a machine unit, in particular via differently configured molded extension guides or molded extension grooves.

In an advantageous manner, the first housing part has at least one connection possibility for mechanically connecting the sensor unit to a machine unit. The use of a commercially available connection possibility is advantageous here. In a particularly advantageous manner, the connection possibility is reversible, in particular in the form of a snap-on hook, bayonet or screw connection. Accordingly, the connection between the sensor unit and the machine unit is nonpositive and/or positive. The connection possibility is advantageously formed as close as possible to, or adjacent to, the contact area, in particular within the molded extension of the first housing part, which borders the contact area. Thus, reliable contacting of the contact area is ensured even in the event of occurring vibrations or shocks caused by the machine unit or other environmental influences.

In a refinement of the invention, it is provided that the second housing part has a visual indicator, in particular formed by an illuminant arranged on the circuit board, and a light guide ending in the second housing part and/or an illuminant formed by a transparent portion in the second housing part. The visual indicator enables a user to detect, for example, correct contacting between the machine unit and the contact area. Likewise, the visual indicator can advantageously output warning signals, for example, in the event of overheating or incorrect contacting. The output of a measured value directly at the sensor unit via the visual indicator is also possible. The illuminant is advantageously designed as at least one LED, wherein it is also possible to use an LCD or a segment display. The light guide or the transparent portion are advantageously connected to the second housing part in a positive, nonpositive or firmly bonded manner, wherein the light guide has substantially the same mechanical properties, in particular similar strengths and similar coefficients of thermal expansion, as the second housing part and accordingly does not represent a weak point with respect to the stability of the second housing part. In a particularly advantageous manner, the light guide or the transparent portion is overmolded by the second housing part, which, on the one hand, forms a positive or firmly bonded non-detachable connection and, on the other hand, a sealing connection. Likewise, the transparent portion can be designed as a through opening, wherein the illuminant itself is positively or nonpositively and sealingly connected to the second housing part.

### BRIEF DESCRIPTION OF THE DRAWINGS

The invention is explained in more detail below with reference to an exemplary embodiment by means of the figures, wherein

FIG. 1 shows a perspective view of the sensor unit,

FIG. 2 shows a perspective exploded view of the sensor unit,

FIG. 3 shows a section of the sensor unit in a side view, and

FIG. 4 shows another section of the sensor unit in another side view.

### DETAILED DESCRIPTION OF EXAMPLE EMBODIMENTS

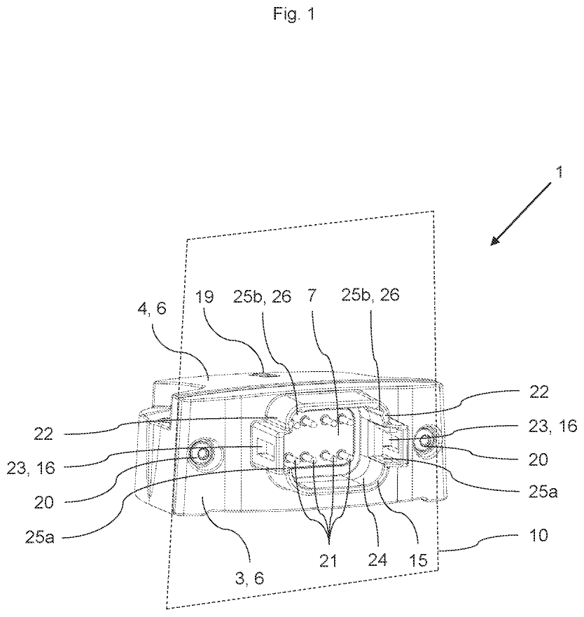

FIG. 1 shows a perspective view of the sensor unit 1, wherein the sensor unit 1 has a first housing part 3 and a second housing part 4, wherein the two housing parts 3, 4 are nonpositively connected to one another by means of two screws 20. The first and second housing parts 3, 4 each have a housing part outer side 6, wherein the housing part outer side 6 of the first housing part 3 is designed in such a manner that a contact area 7 is arranged thereon which is bordered by a molded extension 15 of the first housing part 3. The molded extension 15 has a length which extends orthogonally away from a main plane 10 and which is longer than the length of contact points 21 of the contact area 7 to protect them from impacts and other external influences. Furthermore, the molded extension 15 has a molded extension opening 23 on each of two opposite molded extension walls 22, which forms a connection possibility 16 for mechanically connecting the sensor unit 1 to a machine unit, which is not shown. The molded extension openings 23 can be passed through in particular by means of a snap-on hook, which is not shown, arranged at the machine in order to form a detachable positive connection between the sensor unit 1 and the machine unit. Furthermore, the connection possibility 16 is formed offset from a molded extension inner surface 24 of the molded extension 15 in such a manner that a molded extension guide 25a is formed for attaching the sensor unit 1 to the machine unit. Moreover, the molded extension 15 has two molded extension grooves 26 on the molded extension inner surface 24 thereof, wherein the molded extension grooves 26 have different widths. The molded extension grooves 26 are formed as further molded extension guides 25b and for preventing the sensor unit 1 from being improperly attached onto the machine unit. On its housing part outer side 6, the second housing part 4 has a light guide 19 which is positively connected to the second housing part 4, wherein the light guide 19 is overmolded by the second housing part 4.

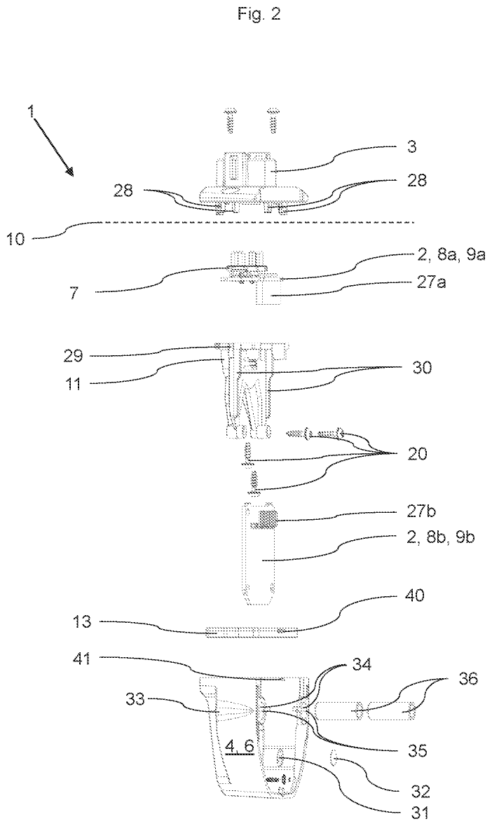

FIG. 2 shows a perspective exploded view of the sensor unit 1, wherein an electronics unit 2 with a first and a second circuit board portion 9a, 9b is arranged in an interior 5, not shown, between the first and second housing parts 3, 4, wherein the circuit board portions 9a, 9b are each formed as individual circuit boards 8a, 8b. The first circuit board 8a is arranged orthogonal to the second circuit board 8b, wherein the first circuit board 8a is arranged parallel to the main plane 10 and contacts the contact area 7, wherein the contact area 7 is attached onto the first circuit board 8a by means of contact points 21 and is machine-soldered onto the first circuit board 8a. A first transmission unit 27a is also arranged on the first circuit board 8a, wherein the first transmission unit 27a receives a second transmission unit 27b arranged on the second circuit board 8b and thus forms the electrically conductive connection between the first and second circuit boards 8a, 8b. A support structure 11 is formed between the first and second circuit boards 8a, 8b and is connected to the first and second circuit boards 8a, 8b via a screw connection by two screws 20 in each case. The two screws 20 for connecting the support structure 11 to the first circuit board 8a are screwed into the first housing part 3, and the first circuit board 8a is therefore clamped between the latter and the support structure 11. The first housing part 3 has lugs 28 received in support structure grooves 29 to ensure reliable positioning of the first circuit board 8a and the support structure 11 on the first housing part 3. The support structure 11 has a frame/framework construction to absorb any stresses or forces that occur and to transmit them as directly as possible to the circuit boards 8a, 8b. Further, the support structure 11 has guide webs 30 which are guided in an invisible guide 12 of the second housing part 4, wherein the guide 12 is formed as a groove. The width of the guide web 30 increases in the direction of the main plane 10. The invisible guide 12 narrows in terms of its width facing away from the main plane 10 so that a nonpositive connection, in particular a clamping connection, is formed between the second housing part 4 and the support structure 11. A reliable hold between the second housing part 4 and the support structure 11 and thus also the electronics unit 2 and the second housing part 4 is thus ensured. A molded seal 13 is formed between the first and second housing parts 3, 4. Furthermore, the molded seal 13 has a molded seal lug 40 which can be received in a molded seal recess 41 of the second housing part 4. Through this arrangement it is advantageously possible to detect, even in the installed state, whether the molded seal 13 is arranged between the first and second housing parts 3, 4. On a housing part outer side 6 of the second housing part 4, which is formed opposite the housing part outer side 6 on which the invisible light guide 19 is arranged, the second housing part 4 has a pressure compensation opening 31 which, in the operating state, is surrounded on one side by a pressure compensation membrane 32. Moreover, the second housing part 4 has two recessed sections 33, wherein section openings 34 are formed at the recessed sections 33, the axes of which are arranged parallel to the main plane 10 and which in turn have section webs 35 extending parallel to the main plane 10 for receiving in each case one sleeve 36. The sleeves 36 can be arranged to be clamped by means of the sectional webs 35 within the sectional openings 34 and are designed to receive a screw and the clamping force associated therewith. Accordingly, the second housing part 4, which is made of a plastic material, is protected from damage or even destruction due to arising clamping forces.

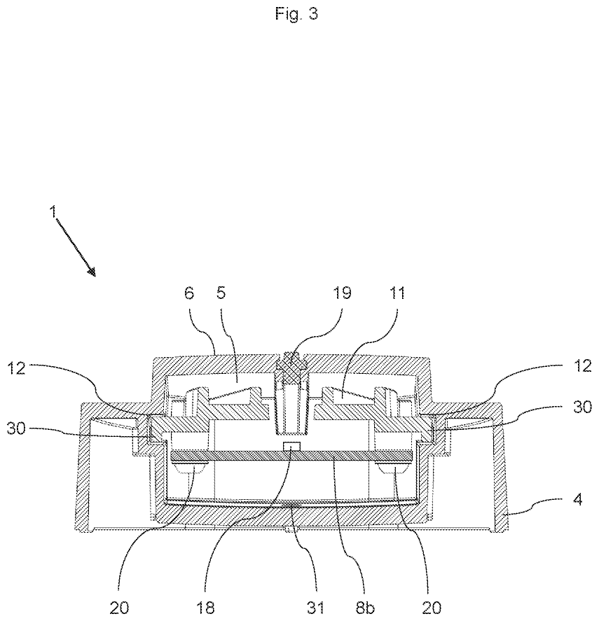

FIG. 3 shows a section of the sensor unit 1 in a side view, wherein the guide webs 30 of the support structure 11 are received within the guides 12 of the second housing part 4. The guide 12 is formed as a groove that narrows extending into the image plane. The light guide 19 is formed in such a manner that it projects from the housing part outer 6 into the interior 5, wherein the distance between the light guide 19 and an illuminant 18 arranged on the second circuit board 8b is as small as possible in order to prevent unwanted scattering of the light from the illuminant 18 as well as damage to the circuit boards 8a, 8b and to the illuminant 18 during disassembly and assembly. The illuminant 18 is designed as an LED which has the states red and green, wherein red stands for a malfunction and green stands for a malfunction-free functionality of the sensor unit 1. The second circuit board 8b is fixedly arranged on the supporting structure 11 by means of screws 20. Opposite the light guide 19, a pressure compensation opening 31 is arranged on the second housing part 4.

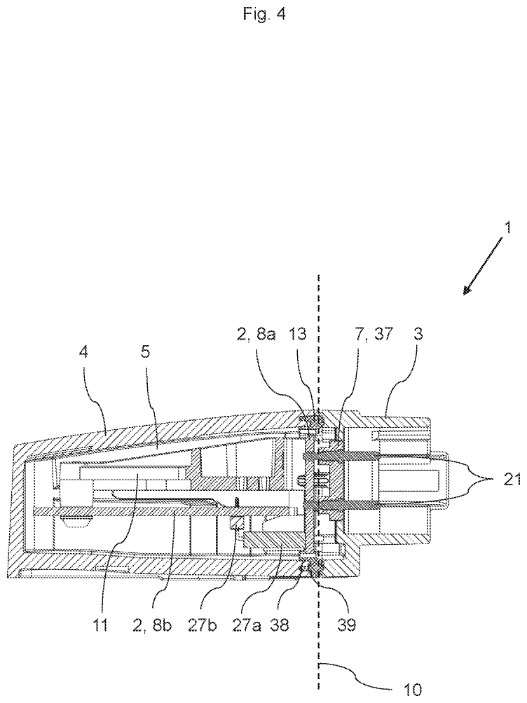

FIG. 4 shows another section of the sensor unit 1 in another side view, wherein the first housing part 3 is passed through by the contact area 7 which has contact points 21 in the form of pins passing through the first circuit board 8a and a contact frame 37. The contact frame 37 is arranged between the contact points 21 and the first housing part 3, rests positively against the first housing part 3 and is press-fitted to the contact points 21. The contact frame 37 is advantageously formed from a material comparable to the first housing part 3 in order to transmit external stresses, forces or vibrations acting on the first housing part 3 directly to the electronics unit 2. Around the first circuit board 8a, the molded seal 13 rests positively against the second housing part 4, wherein the second housing part 4 comprises a molded seal web 39 corresponding to a molded seal groove 38 of the molded seal 13 for positive fit. Contact between the first and second circuit boards 8a, 8b is prevented by the support structure 11, so that the first and second circuit boards 8a, 8b are connected to each other in an electrically conductive manner only via the first and second transmission units 27a, 27b. The first and second circuit boards 8a, 8b are located to the left of the main plane 10, which is defined by a contact surface between first and second housing parts 3, 4. First and second housing parts 3, 4 are formed at their contact surface in such a manner that they receive the molded seal 13 between them adjacent to the contact surface in such a manner that overpressing and thus damage or even destruction of the molded seal 13 is prevented, but functional pressing of the molded seal 13 to form a reliable tightness of the interior 5 is nevertheless possible. The first housing part 3 does not cover the part of the electronic unit 2 projecting into the interior 5.

1. A sensor unit comprising an electronics unit, a first housing part and a second housing part connected thereto, wherein the first and second housing parts form an interior between them and, directed away therefrom, each of them has a housing part outer side, wherein the electronics unit is connected to the first housing part and projects into the interior, wherein a contact area passing through the first housing part is provided, wherein the electronics unit has at least one circuit board with at least two circuit board portions connected to one another in an electrically conductive manner, wherein a first circuit board portion is arranged between the contact area and a second circuit board portion in an electrically conductive manner.

2. The sensor unit according to claim 1, characterized in that the first circuit board portion transmits electrical voltage and/or current applied to the contact area in the operating state to the second circuit board portion substantially unchanged.

3. The sensor unit according to claim 1 or 2, characterized in that wherein the first housing part is designed to be substantially plate-shaped in such a manner that it covers a smaller part of the part of the electronics unit projecting into the interior than the second housing part.

4. The sensor unit according to claim 1, wherein the first housing part covers less than 30% of the part of the electronics unit projecting into the interior.

5. The sensor unit according to claim 1, wherein a circuit board portion of the electronics unit is oriented substantially parallel to a main plane of the plate-shaped first housing part and is fastened therewith to the first housing part, and/or the two circuit board portions are arranged substantially orthogonal to one another.

6. The sensor unit according to claim 1, further comprising a support structure which is fastened to the first housing part and makes contact with the electronics unit.

7. The sensor unit according to claim 1, wherein a molded seal is arranged between the first and second housing parts.

8. The sensor unit according to claim 1, wherein the contact area is designed to be bordered by a molded extension of the first housing part.

9. The sensor unit according to claim 1, wherein the first housing part has at least one connection possibility for mechanically connecting the sensor unit to a machine unit.

10. The sensor unit according to claim 1, wherein the second housing part has a visual indicator.

11. The sensor unit according to claim 4, wherein the first housing part covers less than 10% of the part of the electronics unit projecting into the interior.

12. The sensor unit according to claim 6, wherein the support structure is designed to be guided in a guide of the second housing part.

13. The sensor unit according to claim 10, wherein the visual indicator is formed by an illuminant arranged on the circuit board and a light guide ending in the second housing part and/or an illuminant formed by a transparent portion in the second housing part.
